(19) United States
(12) Patent Application Publication
(10) Pub. No.: US 2025/0286285 A1
(43) Pub. Date: Sep. 11, 2025

(54) Robotic Antenna System for Multiple Satellites Tracking

(71) Applicant: Matsing, Inc., Irvine, CA (US)

(72) Inventors: Serguei Matitsine, Dallas, TX (US); Igor Timofeev, Dallas, CA (US)

(21) Appl. No.: 19/071,296

(22) Filed: Mar. 5, 2025

Related U.S. Application Data
(60) Provisional application No. 63/563,146, filed on Mar. 8, 2024.

(51) Int. Cl. H01Q 19/06; H01Q 3/12

(52) U.S. Cl. CPC H01Q 19/06; H01Q 3/12

(57) ABSTRACT

Multiple low noise block down converter feeds (LNBFs) independently move close to the surface of the lower half of a spherical lens to create N beams for simultaneous tracking of N satellites, preferably containing a visible hemisphere. A spiderlike robot with non-metal arms positions the LNBFs. Each LNBF can have several feeds for different satellite frequency bands. LNBFs can be carried by one or two circular rails, movable arc rails orthogonal to a circular rail, or magnetic coupling to the lens. RC platforms can be autonomous, with connections using Bluetooth™ or other radio links. be Single feeds can be arranged in a chess board arrangement, where each piece of the chess board is responsible for a small three-dimensional angle of the sky. In any of these embodiments, LNBFs can be positioned closer or farther from the lens to create a relative phase shift.

### PRIORITY CLAIM

This application claims priority to U.S. provisional application Ser. No. 63/563,146 filed Mar. 8, 2024. This and all other referenced extrinsic materials are incorporated herein by reference in their entirety. Where a definition or use of a term in a reference that is incorporated by reference is inconsistent or contrary to the definition of that term provided herein, the definition or use of that term provided herein is deemed to be controlling.

### FIELD OF THE INVENTION

The present invention pertains generally to antennas and more particularly to an antenna system configuration for tracking of multiple satellites.

### BACKGROUND OF THE INVENTION

The number of satellites in the sky is growing dramatically, and the task of tracking multiple low orbit/medium orbit (LEO/MEO) satellites has become more challenging. Traditionally, one high gain gimballed reflector antenna (several meters in diameter) with a mechanical pedestal tracks just one satellite. This approach requires a significant number of these expensive antennas and a large real estate area in the case of multiple (say, 10) satellites. Antennas need to be installed tens or hundreds of meters apart to avoid blocking each other when tracking satellites with low elevation angle (see FIG. 1, https://www.usei-teleport.com/). This “antenna farm” can require an area of up to several square kilometers, which is expensive and in many cases is simply impossible (for example, for naval applications).

Prior art also includes phased array antennas for multiple satellite tracking (including conformal hemispherical) https://www.hindawi.com/journals/ijap/2009/230650/ but they are very expensive, have significant gain loss near horizon, narrow operational frequency bandwidth and cannot independently track multiple satellites, when continuous (full time, not part time) downlink is required. There is high demand for compact (square meters, not kilometers) lower-cost antenna system for simultaneous tracking of multiple satellites for full hemisphere coverage (elevation 0° through 180° and azimuth 0° through 360°). There is a need for multi-band, multi-orbit commercial and military capable systems.

### DETAILED DESCRIPTION

The present invention is based on recent advances in metamaterials (e.g., U.S. Pat. No. 8,518,537) which allows for large, (several meters in diameter) lightweight, spherical, multi-beam lensed antennas with high gain of 30-40 dBi and low sidelobe level (<−20 dB) in multi-octave frequency bands.

For simplicity, the following description pertains to capturing several downlinks simultaneously (i. e. Rx only), although it should be appreciated that Tx mode can also be implemented by adding duplexing/Tx circuits.

For several embodiments presented below, common features include: spherical (or quasi-spherical) lens (can be Luneburg or homogeneous), and a set (constellation) of LNBF which create N narrow beams that can be directed to N satellites flying in any point of on the hemisphere (with azimuth 0-360° and elevation 0-90°). LNBF is a low-noise block down converter with feed which contains polarization switch, LNA, mixer, local oscillator with feed https://en.wikipedia.org/wiki/Low-noise_block_downconverter. The N beams (independently controlled) are provided by a set of N LNBFs travelling on the surface of the lower half of lens. One of the main goals of the present invention is to minimize blockage effect by LNBFs (and their moving mechanism) located on opposite side of the lens.

### BRIEF DESCRIPTION OF THE DRAWINGS

FIG. 1 is prior art showing a typical antenna farm for tracking multiple satellites

FIG. 2 shows a first embodiment of the invention using four robotic arms to place four low noise block downconverter feeds (LNBF) on the surface of a spherical lens.

FIG. 3 shows an alternate version of the embodiment of FIG. 2, with eight robotic arms.

FIG. 4 shows a second embodiment of the invention using vertical and horizontal rails to constrain the LNBFs.

FIG. 5A shows a third embodiment of the invention that involves using radio controlled robotic modules that attach to the surface of the spherical lens that allows independent movement of each LNBF.

FIG. 5B shows a side view of the third embodiment individual robotic cart.

FIG. 5C is the same as FIG. 5B, but indicates that the relative position of the robotic cart can change in the radial direction to create a desired phase difference with the other robotic carts for array applications.

FIG. 6A is a variation on embodiment three, where the robotic carts stay in proximity to the lens surface using a magnetic approach.

FIG. 6B shows details of the magnetic attachment using radial magnetic filaments of opposite pole to the robotic cart magnets.

FIG. 7 shows two radiation patterns, with and without the blockage of the radio controlled robotic carts.

FIGS. 8A and 8B show a fourth embodiment, which is a variation on the third approach, but each RC robotic cart is restricted to an area on the lens surface assigned to that RC robotic cart. This is the “chess board” approach.

FIG. 9 also shows a fourth embodiment but indicates that each restricted area can have different sizes.

### DETAILED DESCRIPTION

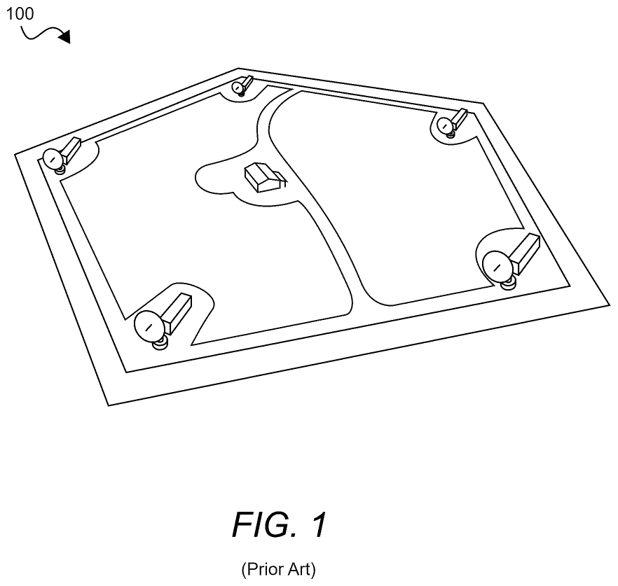

As mentioned previously FIG. 1 is prior art showing antenna farm 100. The antenna farm consists of five separate parabolic antennas taking up approximately a square kilometer of area.

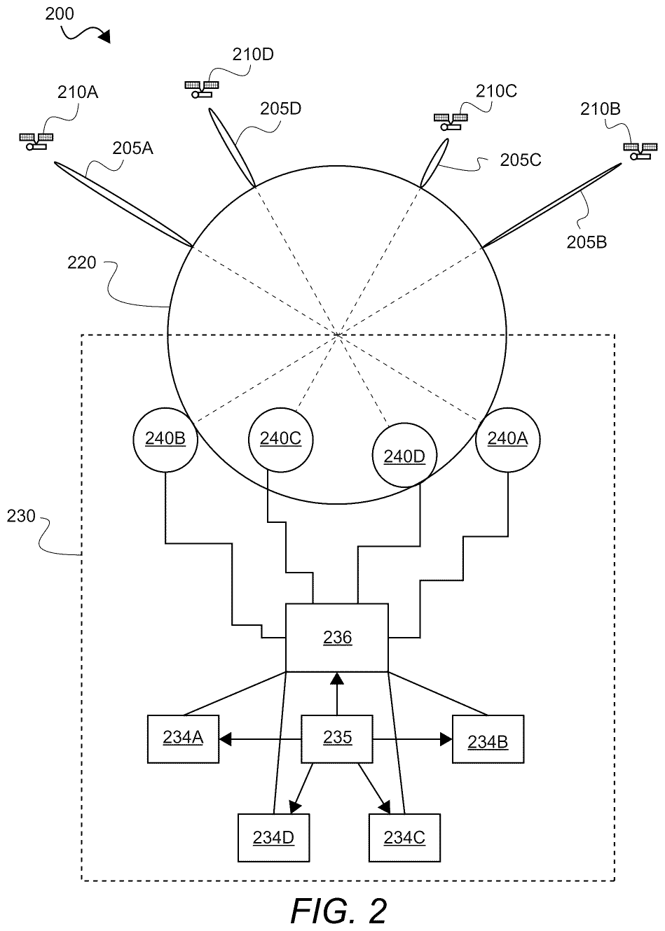

FIG. 2 shows a first embodiment of the invention. The satellite tracking system 200 consists of a large spherical lens antenna 220, including but not limited to a multiple layer Luneburg lens, LNBF 240A, 240B, 240C, 240D, positioned to create, respectively, antenna pattern 205A for reception and transmission to satellite 210A, antenna pattern 205B for reception and transmission to satellite 210B, antenna pattern 205C for reception and transmission to satellite 210C, antenna pattern 205D for reception and transmission to satellite 210D. The robotic arm assembly is shown in 236, IF cable from LNBF 240A attach to receiver 234A, IF cable from LNBF 240B attach to receiver 234B, IF cable from LNBF 240C attach to receiver 234C, and IF cable from LNBF 240D attach to receiver 234D. Positioning of LNBFs is executed by a spiderlike robot with non-metallic (plastic, composite material) robotic arms (manipulators) having thin RF coaxial cables (2˜1 mm) inside. IF signals from LNBFs, bias power and control signals are supplied by this thin coaxial cable. Because LNBF has low weight (0.3-0.6 kg typical), robotic arms can be done thin enough to minimize interference to EM field. Thanks to low cross-sections of arms/cables, there is minimal effect on the radiation field/radiation pattern. (typical gain loss<0.2 dB, typical side lobe level SL<−18 dB).

In FIG. 2, a system 200 of tracking 4 satellites is shown. Narrow (typical 2°-4°) beams 205A, 205B, 205C, 205D directed to satellites 210A, 210B, 210C, 210D correspond to precise positioning of LNBFs 210A, 210B, 210C, 210Don the surface of the lens. These positions are calculated by a processor 235 which generates commands sent to the Spider Robot. The Spider Robot executes commands with its robotic arms to insure the exact position of each LNBF. IF signals IF1, IF2, IF3, IF4 from LNBFs 1, 2, 3, 4 are transmitted to the robotic arms with embedded cables to IF receivers 1, 2, 3, 4, as shown in FIG. 2. During the tracking process, by command from the processor, the satellite can be transferred from one robotic arm to another to avoid mechanical interference between them. The entire assembly is housed in an enclosure 230.

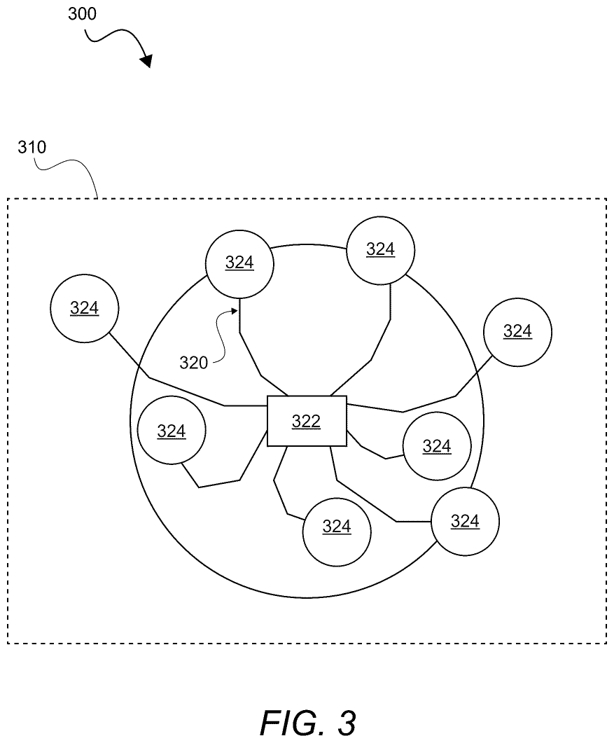

Another view (from the bottom) of spherical lensed antenna with robotic arms 300 is shown in FIG. 3. Here eight LNBF assemblies 324 are connected by spider arms to central assembly 322 via arms 320. All components are housed in housing 310.

Spider robots, or multiarmed positioners having multiple arms (manipulators), have been developed, for example for agriculture (Zion, B., Mann, M., Levin, D., Shilo, A., Rubinstein, D., & Shmulevich, I. (2014). Harvest-order planning for a multiarm robotic harvester. Computers and Electronics in Agriculture, 103, 75-81. LEO and MEO satellites are using circularly polarized signals, therefore rotation of LNBF is not required and cartesian 3.D arms can be used.

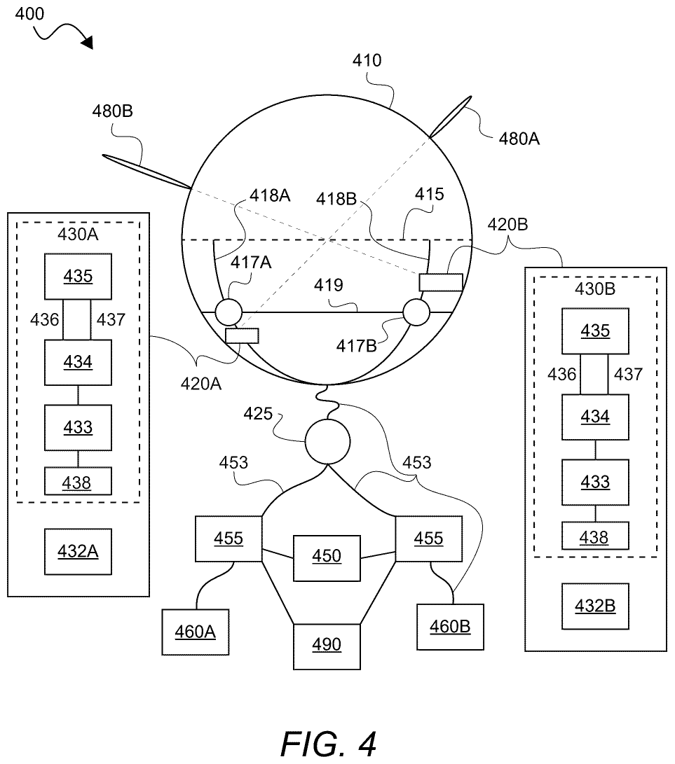

Another embodiment of a multi-satellite tracking system 400, is schematically shown in FIG. 4. It is based on using N platforms, represented by two platforms; 420A and 420B, moving on non-metallic rails. Each movable platform contains an LNBF, these consist of LNBF assemblies 430A and 430B, each containing feed 435, polarization switch 434 which allows selection of either left hand circular polarization (LHCP) 436 or right hand circular polarization (RHCP) 437, using polarization switch 434 connected to a low noise block downconverter (LNB) 433, which transmits/receives communication over the intermediate frequency (IF) channel 438, and vertical motor 1 (432A), and vertical motor 2 (432B). Block diagrams of two platforms (Movable Platform 1 and Movable Platform 2) are shown on the sides of FIG. 4. Vertical motors 1 (432A), and 2 (432B) ensure LNBF 1 (430A), and LNBF 2 (430B) movement in vertical plane along the arc rail 1 (418A), arc rail 2 (418B) (monorail) for beam coverage 0-90° in elevation. When an LNBF is in top position (near equator of lens), antenna beam is directed to horizon, ε=0°. When an LNBF is in bottom position (near pivot, or bottom point of the lens), antenna beam is directed to zenith, ε=90°. In FIG. 4, two beams (from N), Beam 1 and Beam 2, are schematically shown.

Horizontal motor 1 (417A) and horizontal motor 2 (417B), ensure movement of arc rails 1, 2 together with Movable platforms 1 (420A), and 2 (420B) in a horizontal plane along the circular rail 419, for azimuth coverage 0-360°. Feeds are always directed to the center of sphere (as shown by dotted lines in FIG. 4), and with the help of motors, narrow beams can be directed in any point of sky hemisphere (see beam 1 (480A) and beam 2 (480B) in FIG. 4). In total, there are N movable Arc rails and one horizontal Circular rail. An additional horizontal circular rail 415 near equator can be also used for better support of movable arc rails (see dash line in equator in FIG. 4). Arc rails can be hollow inside to provide room for thin (1˜2 mm) cable for IF signals 453. Retractive mechanism, 425, (optional) is ensures smooth IF cable sliding inside arc rail during movement of LNBF. Electrical powering for LNBF1, 2 and Motor1, 2 is done with the same IF cable by Bias Tec, 455, and Power Supply, 490 (see FIG. 4). Control signals from processor 450 are also supplied to motor 1, motor 2 and LNBF (by the same IF cable) from the processor connected to a Bias tee (FIG. 4), connected to receivers 460A, and 460B. Thanks to the low radar cross-sections of the movable platforms 1, 2 and arc rails 1, 2, they do not affect the radiation field/antenna pattern of each other.

Fiber-optic cables (nonmetallic) also can be used for IF signal transmission instead of RF cables for further reduction of EM blockage effect.

LBNFs can be multi-band. Feeds of different bands are located side-by-side or nested inside each other on this moving platform, providing the same LNBF with operation in multiple satellite bands (for example, in L, S, C, X, Ku bands). Multi-band LNBs are available, see for example https://microwave-dynamics.com/productsold/updown-converter-lo-mix-series/?gclid=EAIaIQobChMIt_ma2tro6QIVh5yzCh07pQX6EAMYASAAEgLhzPD_BWE

In some embodiments, LNBFs can have different frequency bands (for example, some of them S band, some of them Ku band).

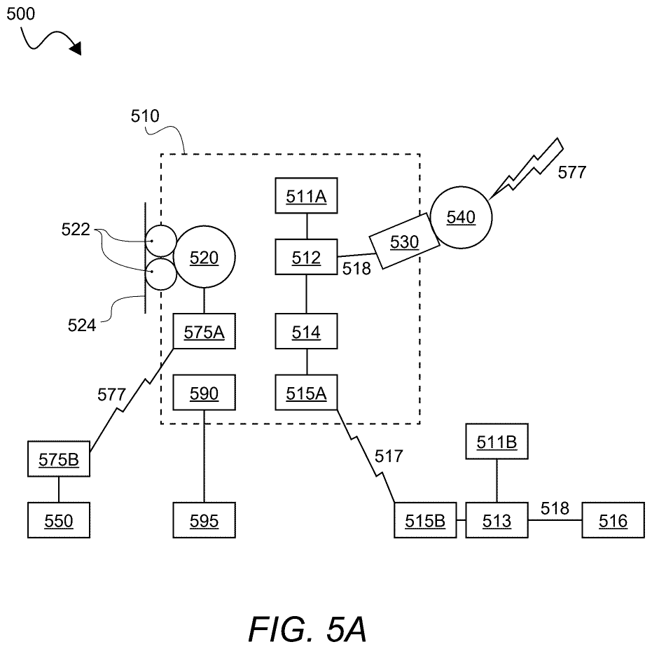

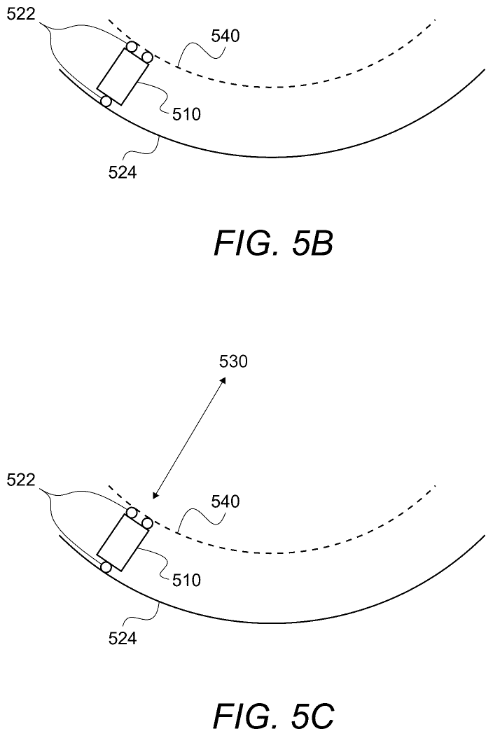

Other embodiments of the invention are based on radio-controlled (RC) platforms, as shown in FIG. 5A-5C. RC platforms 510 (mobile robots) travel near the surface of the lens 540 based on commands from a processor which keeps the LNBF pointed to the center of the lens providing optimum reception of the satellite downlink 577 in FIG. 5A. The RC platform 510 is a small automatic vehicle, with motor 520 and wheels 522 that ride along the radome 524, capable of movement on the spherical surface of the lens, it is carries the LNBF 530 together with equipment for wireless connection, including IF cable 518, connected to up converter 512, that uses local oscillator (LO) 511A to mix to a frequency, providing a signal amplified by amplifier 514 and transmitted by antenna 515A over the wireless link 517 to the complimentary antenna 515B using LO 511B to down converter using down converter 513, to provide IF signal 518 to the stationary IF receiver 516. To organize the beam control link, Bluetooth wireless technology, shown in FIG. 5A with blue tooth module 575A, which over blue tooth link 577, to reciprocal blue tooth module 575B, connected to controller 550, can be used for exchanging data between fixed Controller/Processor and mobile devices (RC platforms) over short distance (in the order of meters) Other wireless modules (for example, Zigbee modules) can also be used for the beam control link.

The data link between the LNBF and IF Receiver can be organized in ISM band (for example 5.725-5.875 GHz or 24-24.5 GHz) of in Wi-Fi 6E band 6-7.125 GHz. Data link equipment at RC platform side contains a local oscillator (LO), up converter, amplifier and antenna (FIG. 5a). Data link equipment at the IF Receiver side contain local oscillator (LO), Down converter, amplifier (optional) and antenna (FIG. 5a). Because of the short distance between lens antenna and IF Receiver (in the order of meters), very low transmission power is needed.

To charge its battery, RC platform can travel to Battery Charging Station 595, which can be located near the bottom of the lens. Another possible solution for charging battery and control of RC platforms is using a laser beam (not shown).

For better coupling between wheels of RC platform and surfaces, rubber wheels, springs and rubber coating of surfaces can be used. In FIG. 5B, RC platform 510 is shown between lens 540 and radome 524, with wheels 522 moving on lens and radome surfaces.

In FIG. 5C, FIG. 5b is repeated but a note indicates that the LNBF can move closer or farther from the lens surface to create a differential phase shift, indicated by 530, used to create the same effect as a phase shifter between separate LNBFs. This technique applies to all embodiments.

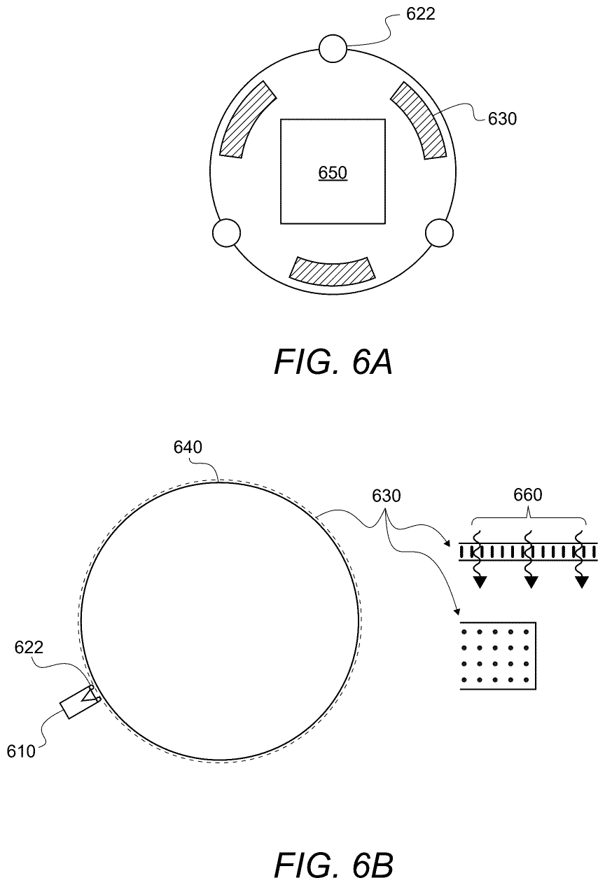

In FIG. 6A another method of attachment of RC platform to lens surface (without additional shell) is shown. This method is based on the using of magnetic layer located on the surface of the lens. Here the RC platform has magnets 630 and wheels, around feed 650 and magnetic force (oriented to the center of the lens) is holding RC platform on the magnetic layer. In FIG. 6B, the RC platform 610, with wheels 622, a layer containing short magnetic needles 630, (about 2-5 mm, much less than a wavelength) are oriented perpendicular to the lens surface, 640. The layer is transparent to electromagnetic (EM) waves 660 because E and H vectors are orthogonal to magnetic needles, which can be made, for example, from iron or ferrites.

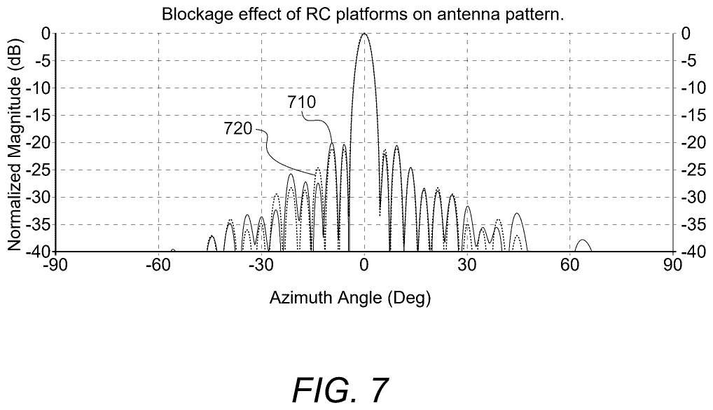

The advantage of using of RC platforms (FIG. 5A, 6A) compared to the embodiments shown in FIGS. 2-4 is lack of cables, arms and rails which allows to further minimize blockage effect and improve the antenna pattern. The RC platform is configured to have minimal footprint (about λ²) in the direction orthogonal to lens surface. Because directivity gain of the satellite tracking antenna is typically 36 dB, aperture area is about 1000 λ²/π with maximal blocked area is 0.1(N−1)π%. If N=10, less than 3% of aperture can be blocked which means 0.1 dB max gain loss and negligible increase in sidelobes. For example, SL increased to −20 dB from initial −21 dB, as shown in calculated antenna pattern of FIG. 7, where the pattern 710 without blockage is slightly better than the pattern 720 with blockage.

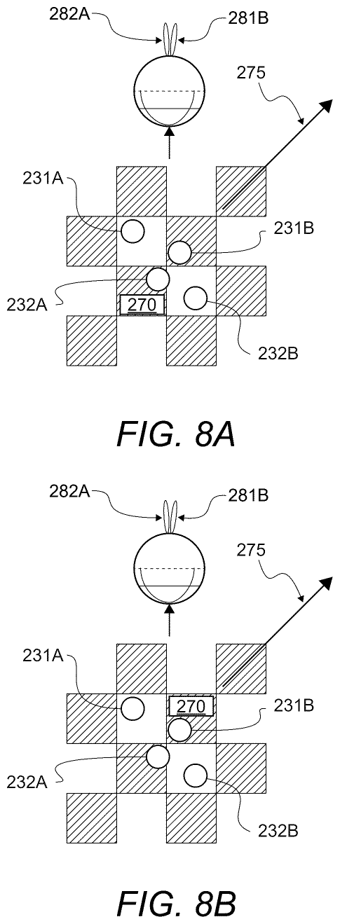

FIGS. 8A, 8B show variations on the RC cart approach, the chessboard approach. Here each RC cart, indicated as 231A, with beam 281B, 231B, with beam 231A, 232A (beam not shown), and 232B (beam not shown), containing one LNBF and communication module stays with an area (as shown a square area, 270, but the shape of the area is arbitrary and can be circular, elliptical, hexagonal, any irregular closed surface). The processor algorithm for tracking the satellites, in direction 275 includes a “hand-off” capability from square to square (shown by the difference between FIG. 8A and FIG. 8B), as a given satellite traverses the sky. FIG. 8B represents the time period when the satellite (here we use a single satellite but the concept is amenable to tracking multiple satellites simultaneously) is being tracked by beam 282A. Just as with the above embodiments the LNBF moves anywhere within its defined square. FIG. 8b represents the time period after the hand-off has occurred. The advantage of this capability is it does not allow for any given LNBF crossing the path of another LNBF allowing for a cabled approach compared to the more difficult and expensive approach of a separate wireless system to communicate the output of the LNBF.

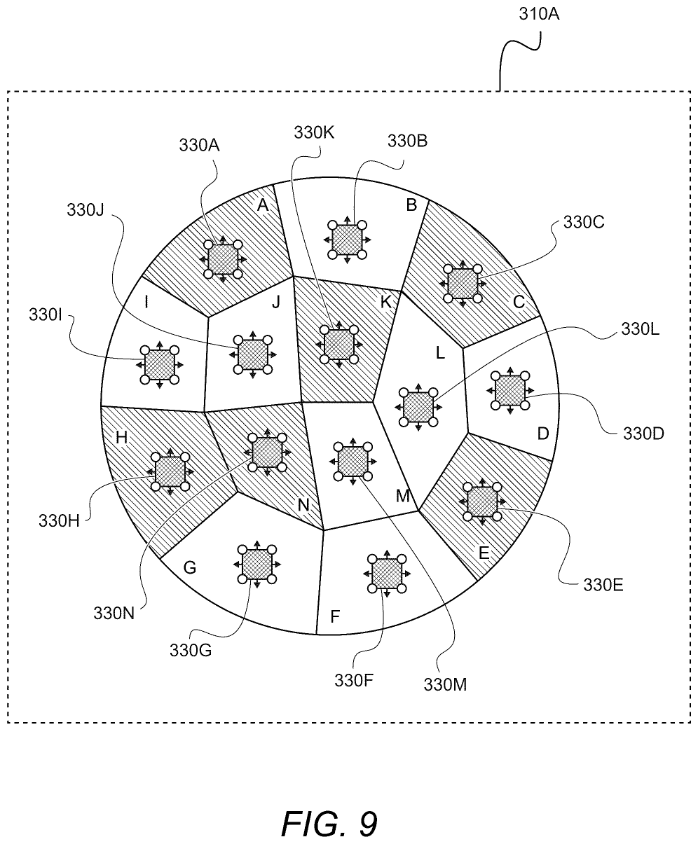

FIG. 9 shows the RC cart chessboard approach where arbitrary surfaces load out in area 310A are indicated by the letters A through N (14 surfaces). Each of the 14 surfaces contain an RC cart 330A, 330B, 330C, 330D, 330E, 330F, 330G, 330H, 330I, 330J, 330K, 330L, 330M, or 330N, which is capable of movement within its defined surface to track a satellite. An approach is envisioned where a cart from one region, e.g. region B would hand off, through signal processing not shown or detailed, to a cart in region I. In this way a satellite could be tracked across the sky by a series of handoffs between carts covering their own particular region.

In some embodiments of the invention, lens can have quasi-spherical shape, for example: truncated, oblate or prolate.

As shown above by proposed compact antenna systems, several different beams can connect at once with several satellites operating at various altitudes within different orbits and in different frequency bands. Compared to prior art (shown in FIG. 1), the proposed antenna solutions requires much less real estate (few square meters, not hundreds or thousands square meters). Phased arrays from prior art also, by contrast with proposed solutions, require a larger form factor which consumes more real estate, and significantly more electrical power with much less operational frequency bandwidth.

What is claimed is:

1. A system for communicating with a device, comprising:
a first RF element configured to communicate with the device using signals passing through a first lens; and
a first positioning assembly configured to track apparent movements of device by physically moving the first RF element about the first lens in three dimensions (r, theta, and phi) of a spherical coordinate.

2. The system of claim 1, wherein the first lens is spherical.

3. The system of claim 1, wherein the first lens comprises at least a truncated sphere.

4. The system of claim 1, wherein the first lens comprises at least a cylindrical portion.

5. The system of claim 1, further comprising:
a second RF element configured to move about the first lens in the three dimensions (r, theta, and phi) of the spherical coordinate; and
a controller configured to hand-off processing of the signals between the first RF element and the second RF element.

6. The system of claim 5, further comprising a controller configured to control movement of the first positioning assembly to move first RF element in the r direction, to alter a phase of the signals received by the first RF element.

7. The system of claim 1, wherein the device is a satellite observable by the first RF element as passing through from a first region of the sky to a second region of the sky, and the controller is configured to hand-off processing of the signals between the first RF element and the second RF element as the device approaches a boundary between the first and second regions of the sky.

8. The system of claim 1, further comprising:
a second RF element configured to move about a different second lens in the three dimensions (r, theta, and phi) of the spherical coordinate; and
a controller configured to hand-off processing of the signals between the first RF element and the second RF element.

7. The system of claim 1, wherein the first lens and the first positioning assembly are disposed on a first moveable cart.

8. The system of claim 1, wherein the first positioning assembly comprises a first manipulator arm.

9. The system of claim 1, wherein the first positioning assembly comprises an arc rail upon which the first RF element is movably coupled.
